(19) United States
(12) Patent Application Publication
(10) Pub. No.: US 2014/0003038 A1
(43) Pub. Date: Jan. 2, 2014

(54) LIGHTING APPARATUS USING SOLAR CELL

(71) Applicants: Hyun-Chul KIM, Yongin-si (KR); Nam-Seok BAIK, Yongin-si (KR); Ji-Won LEE, Yongin-si (KR); Jong-Ho YOON, Yuseong-gu (KR); Sang-Kun HWANG, Namyangju-si (KR); Sung-Su KIM, Yongin-si (KR)

(72) Inventors: Hyun-Chul KIM, Yongin-si (KR); Nam-Seok BAIK, Yongin-si (KR); Ji-Won LEE, Yongin-si (KR); Jong-Ho YOON, Yuseong-gu (KR); Sang-Kun HWANG, Namyangju-si (KR); Sung-Su KIM, Yongin-si (KR)

(73) Assignee: SAMSUNG SDI CO., LTD., Yongin-si (KR)

(21) Appl. No.: 13/741,682

(22) Filed: Jan. 15, 2013

(30) Foreign Application Priority Data
Jul. 2, 2012 (KR) 10-2012-0071968

(51) Int. Cl. F21S 8/00; F21L 4/08; F21L 4/02

(52) U.S. Cl. CPC F21S 8/00; F21L 4/02; F21L 4/08
USPC 362/145; 362/183

(57) ABSTRACT

A lighting apparatus using a solar cell includes a window frame that frames a window area, a photoelectric panel in the window area, a battery unit that stores electric power generated from the photoelectric panel, and a lighting unit that receives a power supply voltage from the battery unit and provides indirect lighting, the lighting unit being on the window frame, and an optical axis of the lighting unit extends in a direction facing the photoelectric panel.

### CROSS-REFERENCE TO RELATED APPLICATION

This application claims priority under 35 U.S.C. §119 to Korean Patent Application No. 10-2012-0071968, filed on Jul. 2, 2012, in the Korean Intellectual Property Office, and entitled: “Exterior Lighting Apparatus Using Solar Cell,” the entire contents of which is incorporated herein by reference.

### BACKGROUND

The decorative lighting of a building may raise the value of the building, leading to interest in and use of such decorative lighting.

### SUMMARY

Embodiments are directed to a lighting apparatus using a solar cell, the apparatus including a window frame that frames a window area, a photoelectric panel in the window area, a battery unit that stores electric power generated from the photoelectric panel, and a lighting unit that receives a power supply voltage from the battery unit and provides indirect lighting, the lighting unit being on the window frame, and an optical axis of the lighting unit extends in a direction facing the photoelectric panel.

The photoelectric panel may include a dye-sensitized solar cell or an organic solar cell.

The lighting apparatus may be an exterior lighting apparatus further including a glass panel that transmits an incident light as indoor lighting.

The window frame may frame a plurality of window areas, and the photoelectric panel and the glass panel may be in different window areas.

The lighting unit may include a light-emitting diode (LED) array arranged along the window frame.

The lighting apparatus may be an exterior lighting apparatus, a flange portion of an end portion of an outdoor side of the window frame may be bent to be opposite to the photoelectric panel, and the lighting unit may be on the flange portion.

The flange portion may include an aluminum material.

The photoelectric panel may be fixed to the window frame with a hinge so that the photoelectric panel rotates with respect to the window frame.

The window frame may include a base frame that faces a first side of the photoelectric panel and extends across a lateral side of the photoelectric panel, and a coupling frame that faces a second side of the photoelectric panel and is coupled to the base frame, the second side being opposite the first side.

The photoelectric panel may be fixed between the base frame and the coupling frame.

The lighting unit may face the photoelectric panel, the base frame, and the coupling frame.

There may be an interconnection space between the base frame and the coupling frame, and the interconnection space may accommodate a first interconnection line that electrically connects the lighting unit and the battery unit, and a second interconnection line that electrically connects the photoelectric panel and the battery unit.

The lighting unit may be an exterior lighting unit on an exterior side of the window frame, and the lighting unit may be hidden by the window frame when viewed from the exterior side.

The lighting apparatus may further include an ultraviolet ray blocking film on the photoelectric panel.

Embodiments are also directed toward a lighting apparatus using a solar cell, the apparatus including a first panel and a second panel that face each other, a supporting frame interposed between the first panel and the second panel, a photoelectric panel fixed to the supporting frame, a battery unit that stores electric power generated from the photoelectric panel, and a lighting unit that receives a power supply voltage from the battery unit and provides indirect lighting, the lighting unit being on the supporting frame, and an optical axis of the lighting unit extends in a direction parallel to the photoelectric panel.

The supporting frame may include a base frame that is on a first side of the photoelectric panel, and a coupling frame that is on a second side of the photoelectric panel and is coupled to the base frame, the second side being opposite the first side.

The photoelectric panel may be fixed between the base frame and the coupling frame.

The lighting unit may be on the coupling frame and may be protected by a cover element that is coupled to the coupling frame.

The cover element may be detachably coupled to the coupling frame.

The first panel may be an external panel, the second panel may be an internal panel, the lighting unit may be an exterior lighting unit and may be between the photoelectric panel and the first panel.

### BRIEF DESCRIPTION OF THE DRAWINGS

Features will become apparent to those of skill in the art by describing in detail exemplary embodiments with reference to the attached drawings in which:

FIG. 1 illustrates a lighting apparatus using a solar cell, according to an embodiment;

FIG. 2 illustrates a cross-sectional view taken along line II-II of FIG. 1;

FIG. 3 illustrates a cross-sectional view of a photoelectric panel of FIG. 2 in more detail;

FIG. 4 illustrates a lighting apparatus using a solar cell, according to an embodiment;

FIG. 5 illustrates a cross-sectional view taken along line V-V of FIG. 4;

FIG. 6 illustrates a hinge structure of a photoelectric panel in FIG. 4;

FIG. 7 illustrates a perspective view of a lighting apparatus using a solar cell, according to an embodiment; and

FIG. 8 illustrates a cross-sectional view taken along line VIII-VIII of FIG. 7.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers or elements may also be present. Further, it will be understood that when a layer or element is referred to as being “under” another layer or element, it can be directly under, and one or more intervening layers or elements may also be present. In addition, it will also be understood that when a layer or element is referred to as being “between” two layers or elements, it can be the only layer or element between the two layers or elements, or one or more intervening layers or elements may also be present. Like reference numerals refer to like elements throughout.

Throughout the specification, terms like “exterior,” “interior,” “outside,” “inside,” “outdoor,” “indoor,” “external,” “internal,” and the like may be used; however, these terms are used only to describe exemplary embodiments, and the lighting apparatus is not limited by these terms. That is, an element that is described as being, e.g., exterior or facing outside may also be interior or facing inside.

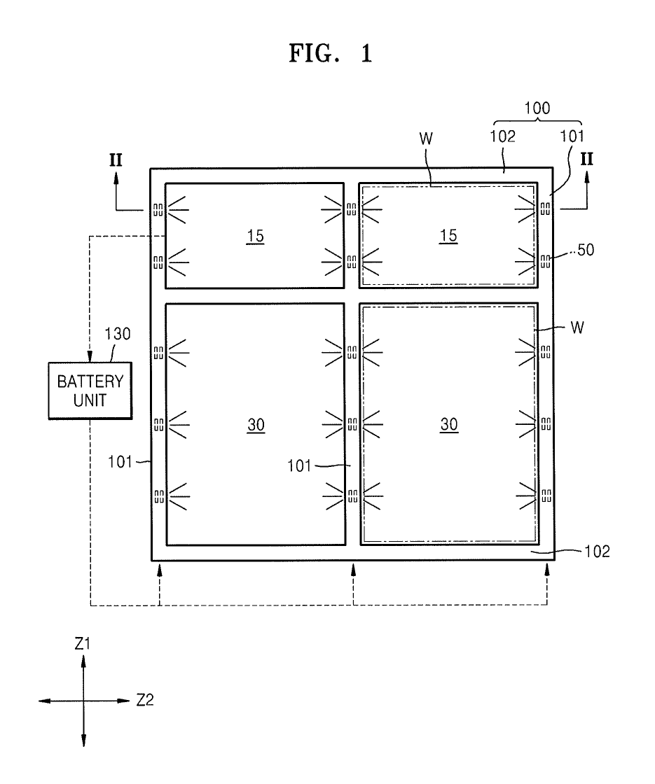

FIG. 1 illustrates a lighting apparatus using a solar cell, according to an embodiment.

Referring to FIG. 1, the lighting apparatus may include a window frame 100 that forms an external frame, a plurality of photoelectric panels 15 fixed to the window frame 100, a battery unit 130 that stores electric power generated by the photoelectric panels 15, and a plurality of lighting units 50 that receive the electric power from the battery unit 130 and are fixed to the window frame 100 together with the photoelectric panels 15. The lighting apparatus may be an exterior lighting apparatus, and the lighting units 50 may be exterior lighting units 50.

The window frame 100 may be formed to define a plurality of window areas W each having a substantially rectangular form (other shapes may also be used), and may fix the photoelectric panels 15 disposed in the window areas W to a wall of a building (not shown). The window frame 100 may fix a plurality of glass panels 30 as well as the photoelectric panels 15 to the window areas W, and may fix the photoelectric panels 15 and the glass panels 30 to different window areas W.

For example, the window frame 100 may include a plurality of first frames 101 that extend side-by-side in a first direction Z1 and a plurality of second frames 102 that extend side-by-side in a second direction Z2, and the plurality of window areas W may be defined by the first and second frames 101 and 102. For example, the glass panels 30 may be disposed in window areas W located on the center portion and/or the lower portion of the window frame 100, and the photoelectric panels 15 may be disposed in window areas W located on the upper portion of the window frame 100. The glass panels 30 and the photoelectric panels 15 may be disposed in different window areas W, respectively.

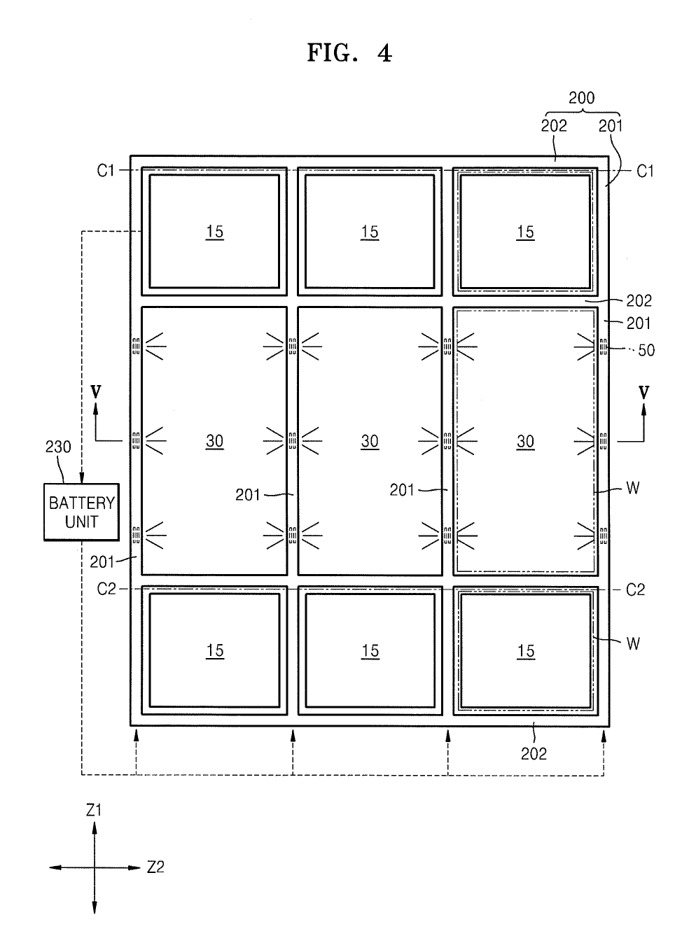

As another example, the window frame 100 may define window areas W located in the center of the window frame 100 and window areas W located on the upper portion and lower portion of the window frame 100. In this case, the glass panels 30 may be disposed in window areas W located on the center portion of the window frame 100, and the photoelectric panels 15 may be disposed in window areas W located on the upper and lower portions of the window frame 100 (e.g., as illustrated in FIG. 4 and discussed below).

The photoelectric panels 15 may receive an incident light and may perform an electric power generation operation for outputting electric energy. The glass panels 30 may transmit most of the incident light and may perform a lighting arrangement function that allows the incident light to pass through them toward an indoor side.

As described above, the exterior lighting apparatus may include the battery unit 130 that stores the electric power generated by the photoelectric panels 15 and supplies the electric power to the exterior lighting units 50. For example, electric power generated by the photoelectric panels 15 during the daytime may be stored in the battery unit 130, and the electric power stored in the battery unit 130 may be used as a driving electric power for driving the exterior lighting units 50 at night. Accordingly, a power supply for the exterior lighting units 50 may not be needed and thus power costs may be reduced (while a power supply may not be needed, it may still be used).

The battery unit 130 may include a battery for storing electric power and a power converter (not shown). The power converter may include a converter for converting the electric power generated by the photoelectric panels 15 into a voltage level that is required by the battery. For example, the power converter may include a DC-DC converter that converts DC electric power output from the photoelectric panels 15 to another DC electric power. For example, the power converter may include a converter that converts the electric power generated by the photoelectric panels 15 into a voltage level that is required by the battery, on a charge path, and may include another converter that converts the electric power stored in the battery into a voltage level that is required by the exterior lighting units 50, on a discharge path. The charge path may be an interconnection line through which the electric power generated by the photoelectric panels 15 is input to the battery, and the discharge path may be an interconnection line through which the electric power stored in the battery is output to the exterior lighting units 50.

The exterior lighting units 50 may be arranged along the first frames 101 of the window frame 100, and may include a light-emitting diode (LED) array arranged along the first frames 101. The exterior lighting units 50 may be disposed in a buried form in the window frame 100. That is, the exterior lighting units 50 may be in the first frames 101 so that the exterior lighting units 50 are not observed from the outside. As described below, the exterior lighting units 50 may implement indirect lighting in which a light source is not directly exposed to the outside, and thus may provide an elegant lighting effect with a dim and soft visual effect. In an embodiment, the exterior lighting units 50 may be arranged along the second frames 102 of the window frame 100, or may be arranged along the first and second frames 101 and 102 of the window frame 100.

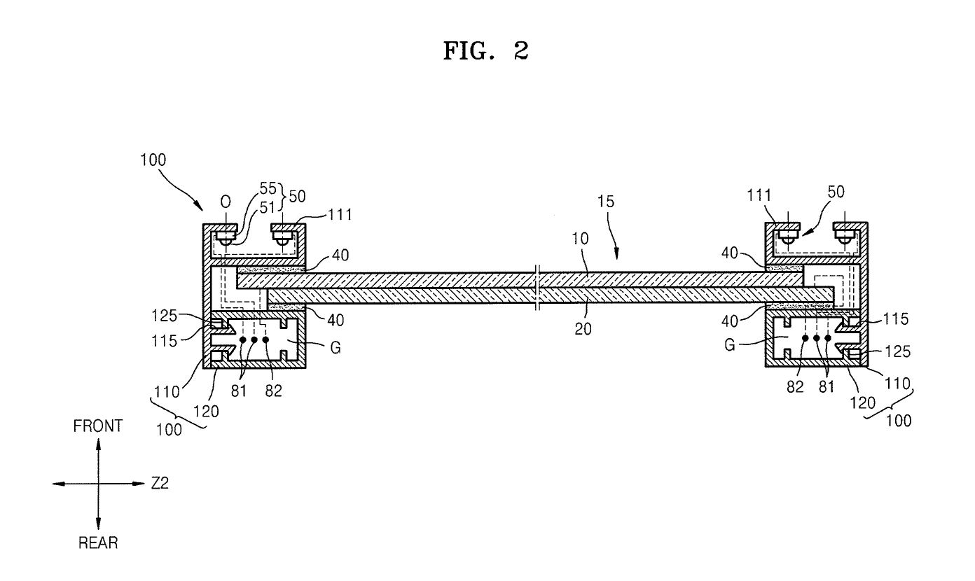

FIG. 2 illustrates a cross-sectional view taken along line II-II of FIG. 1. The front and rear indicated in FIG. 2, and referenced throughout the specification, indicate a front side as an outdoor side and a rear side as an indoor side.

Referring to FIG. 2, the window frame 100 may be coupled to edges of the photoelectric panel 15 and may fix the position of the photoelectric panel 15 by supporting the edges. The window frame 100 may include a base frame 110 that extends indoors and outdoors, that is, to the front and rear, and a coupling frame 120 that is coupled at the rear side of the base frame 110 and supports the photoelectric panel 15 between the base frame 110 and the coupling frame 120.

The base frame 110 may be opposite to the front of the photoelectric panel 15 (i.e., may overlap a portion of the front side of the photoelectric panel 15) and may extend to the rear side of the photoelectric panel 15 by crossing the lateral side of the photoelectric panel 15. The coupling frame 120 may be opposite to the rear of the photoelectric panel 15 (i.e., may overlap a portion of the rear side of the photoelectric panel 15) and may be coupled to the base frame 110 to fix the photoelectric panel 15 between the base frame 110 and the coupling frame 120. For example, the base frame 110 may be close to (e.g., connected to) the front of the photoelectric panel 15 by interposing a bumper 40, and the coupling frame 120 may be close to (e.g., connected to) the rear of the photoelectric panel 15 by interposing the bumper 40. The use of the terms “front” and “rear” above are by way of example, and the base frame 110 and the coupling frame 120 may also be disposed opposite to the rear of the photoelectric panel 15 and the front of the photoelectric panel 15, respectively, and may be close to the rear of the photoelectric panel 15 and the front of the photoelectric panel 15, respectively, by interposing a bumper 40.

A coupling portion 115 and a coupling portion 125 may be coupled to each other, and may be formed in the base frame 110 and the coupling frame 120, respectively. For example, the coupling portion 115 may be formed in the base frame 110 and may include a pair of limb portions, and the base frame 110 and the coupling frame 120 may be coupled to each other by the limb portions of the coupling portion 115 catching onto a clasp, i.e., the coupling portion 125, of the coupling frame 120.

A flange portion 111 may be formed at a front end portion of the base frame 110. For example, a pair of flange portions 111 may be bent to be opposite to each other and may be formed at the front end portion of the base frame 110, and the exterior lighting units 50 may be supported on the flange portions 111. The flange portions 111 may be bent in a direction facing the front of the photoelectric panel 15. The exterior lighting units 50 disposed on the flange portions 111 may emit light in a direction facing the photoelectric panel 15.

The optical axis O of the exterior lighting units 50 may be set in the direction facing the photoelectric panel 15. For example, the optical axis O of the exterior lighting units 50 may be set in a direction substantially perpendicular to the front of the photoelectric panel 15. The exterior lighting units 50 may be supported on the flange portions 111 of the window frame 100, the flange portions 111 may be formed to be bent in the direction facing the photoelectric panel 15, and the exterior lighting units 50 mounted on the flange portions 111 may emit light in the direction facing the photoelectric panel 15. In this case, the exterior lighting units 50 may emit light to the indoor side, i.e., the rear side, to implement indirect lighting.

The exterior lighting units 50 may not directly expose light sources to the outside and may implement indirect lighting that uses light reflected or diffused from the light sources. Accordingly, the dazzling effect that occurs when directly emitting light to the outside may be substantially prevented. The indirect lighting may reduce visual unpleasantness, may substantially prevent accidents that may be caused by disturbing awareness of the circumference of direct lighting, and/or may reduce light pollution, all of which may be problems that result from light that is directly emitted from the exterior lighting units 50.

In addition, the exterior lighting units 50 may provide an elegant light effect (e.g., appearance) having a dim and soft visual effect by implementing the indirect lighting without using light directly emitted from the light sources, and thus may improve an appearance of the exterior of a building and may provide an elegant lighting effect.

Each of the exterior lighting units 50 may include an LED device, or may include an LED array including a plurality of LED devices. The exterior lighting units 50 may be arranged along the first frame 101 of the window frame 100.

The exterior lighting units 50 may directly or indirectly receive a driving electric power from the photoelectric panel 15. For example, the exterior lighting units 50 may directly receive the electric power generated from the photoelectric panel 15, or may receive the electric power from the battery unit 130 of FIG. 1, which stores the electric power generated by the photoelectric panel 15. For example, electric power generated by the photoelectric panels 15 during the daytime may be stored in the battery unit 130, and the electric power stored in the battery unit 130 may be used as a driving electric power for driving the exterior lighting units 50 at night. For this, the exterior lighting units 50 may be electrically connected to the battery unit 130 and may use the electric power stored in the battery unit 130 as a power supply.

A first interconnection line 81 for supplying the electric power from the battery unit 130 to the exterior lighting units 50 may extend from the exterior lighting units 50 to the battery unit 130 and may be formed in the window frame 100. For example, the first interconnection line 81 may be disposed in an interconnection space G of the window frame 100 and may extend along the window frame 100. The interconnection space G may be formed by coupling of the base and coupling frames 110 and 120. For example, the first interconnection line 81 may extend from the exterior lighting units 50 to the interconnection space G by penetrating or passing through the base frame 110 and the coupling frame 120.

The exterior lighting units 50 each may include a light-emitting unit 51 and a circuit substrate 55 for supplying an electrical signal to the light-emitting unit 51. The first interconnection line 81 for supplying the electric power from the battery unit 130 to the exterior lighting units 50 may extend from the circuit substrate 55 to the battery unit 130.

The window frame 100 to which the exterior lighting units 50 are attached may be formed of a metal material, e.g., an aluminum material. The window frame 100 formed of a metal material may function as a heat dissipation plate against heat of the exterior lighting units 50. That is, it may not be necessary to install a separate heat dissipation plate for dissipating heat by installing the exterior lighting units 50 on the window frame 100 (although a separate heat dissipation plate may also be used). The whole window frame 100 may be formed of a metal material, or a portion of the window frame 100 may be formed of a metal material, for example, the flange portions 111 on which the exterior lighting units 50 are mounted and/or the base frame 110, may be selectively formed of a metal material.

LED devices that may be used as the exterior lighting units 50 may generate a driving heat during light-emitting, and thus, a light-emitting efficiency may be lowered. For example, light intensity may be decreased due to an accumulation of the driving heat. The exterior lighting units 50 may be directly mounted on the window frame 100 formed of a metal material, and thus it may be possible to remove the driving heat through the window frame 100 thereby improving the light-emitting efficiency of the exterior lighting units 50.

As described above, the photoelectric panel 15 fixed to the window frame 100 may receive an incident light and perform an electric power generation operation. The electric power generated by the photoelectric panel 15 may be stored in the battery unit 130. The photoelectric panel 15 may be formed by coupling first and second substrates 10 and 20 to be opposite to each other, and a function layer (not shown in FIG. 2) for performing a photoelectric conversion may be formed between the first and second substrates 10 and 20. As described below, each of the function layers formed between the first and second substrates 10 and 20 may include a semiconductor layer for generating excited electrons from the incident light and electrodes for collecting the generated electrons and outputting them to the outside.

The first and second substrates 10 and 20 that form a pair may be disposed offset from each other in left and right directions (Z2 direction). A left side portion of the first substrate 10 may be offset from a left side portion of the second substrate 20 to expose an electrode (not shown in FIG. 2) of the first substrate 10, and a right side portion of the second substrate 20 may be offset from a right side portion of the first substrate 10 to expose an electrode (not shown in FIG. 2) of the second substrate 20. A second interconnection line 82 may extend from the exposed electrode to the interconnection space G. For example, the second interconnection line 82 may be used for transmitting the electric power generated by the photoelectric panel 15 to the battery unit 130. That is, the electric power generated by the photoelectric panel 15 may be supplied to the battery unit 130 through the second interconnection line 82, and the supplied electric power may be used to charge the battery unit 130.

Although FIG. 2 only illustrates the case where the window frame 100 fixes the photoelectric panel 15, as illustrated in FIG. 1, the window frame 100 may also extend to fix the glass panel 30 together with the photoelectric panel 15. The photoelectric panel 15 and the glass panel 30 may be fixed together by the window frame 100 with substantially the same structure described above.

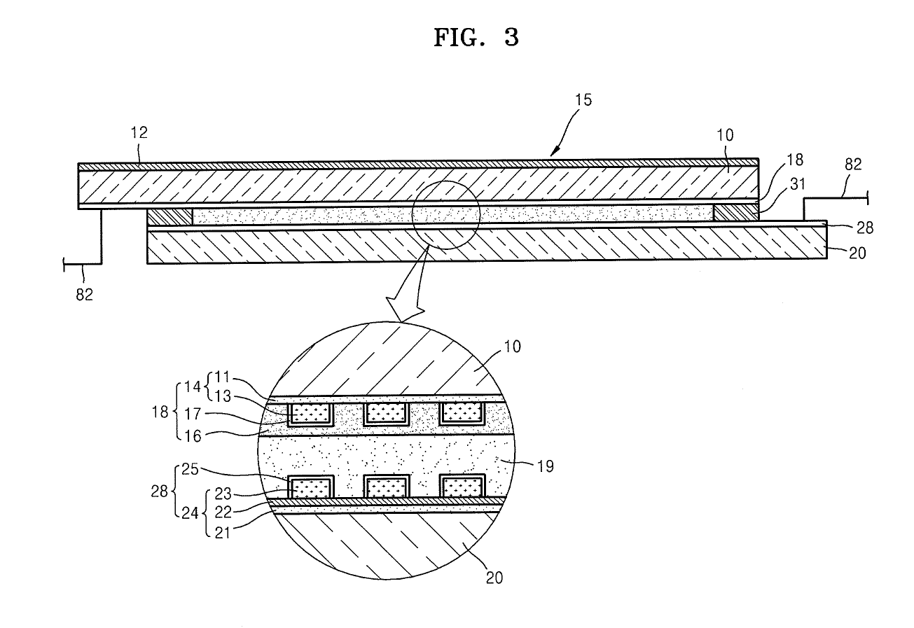

FIG. 3 illustrates a cross-sectional view illustrating the photoelectric panel 15 of FIG. 2 in more detail. Referring to FIG. 3, the photoelectric panel 15 may be formed of a dye-sensitized solar cell or an organic solar cell.

The photoelectric panel 15 may be formed by arranging the first and second substrates 10 and 20, on which first and second function layers 18 and 28 for performing a photoelectric conversion are formed respectively opposite to each other, interposing sealing elements 31 at edge portions of the first and second substrates 10 and 20 between the first and second substrates 10 and 20, and then injecting an electrolyte 19 to the inside of the photoelectric panel 15 through an electrolyte inlet (not shown).

The first function layer 18 on the first substrate 10 may include a semiconductor layer 16 for generating excited electrons from incident light and a photoelectrode 14 for collecting the generated electrons and outputting them to the outside. The semiconductor layer 16 may adsorb a photosensitive dye (not shown) that is excited by the incident light and may be formed on the photoelectrode 14. The photoelectrode 14 may include a transparent conductive film 11 formed on the whole surface of the first substrate 10 and a grid electrode 13 formed on the transparent conductive film 11 in a form of a pattern. A protection layer 17 may be formed on the external surface of the grid electrode 13. The photoelectrode 14 may form a negative electrode of the photoelectric panel 15.

The second function layer 28 of the second substrate 20 may include a counter-electrode 24 that forms an opposition electrode of the photoelectrode 14, for example, an positive electrode of the photoelectrode 14, and the counter-electrode 24 may include a transparent conductive film 21 formed on the whole surface of the second substrate 20, a catalytic layer 22 formed on the transparent conductive film 21, and a grid electrode 23 formed on the catalytic layer 22 in the form of a pattern. A protection layer 25 may be formed on the surface of the grid electrode 23, which may be exposed to an electrolyte 19. As shown in FIG. 3, the first and second substrates 10 and 20 may be disposed offset from each other, and thus one side portion of a left side of the first substrate 10 may be exposed to the outside, and the first function layer 18 formed on the first substrate 10 may be electrically connected to the second interconnection line 82 at the exposed one side portion of the left side of the first substrate 10.

Similarly, one side portion of a right side of the second substrate 20 may be exposed to the outside, and the second interconnection line 82 may be electrically connected to the exposed one side portion of the right side of the second substrate 20. The structure of the photoelectric panel 15 illustrated in FIG. 3 is exemplary, and other suitable structures may also be used.

As illustrated in FIG. 3, an ultraviolet ray blocking film 12 may be formed on a surface of the photoelectric panel 15, through which light is received, for example, on the first substrate 10 supporting the semiconductor layer 16. The ultraviolet ray blocking film 12 may prevent change in quality, such as oxidization of a photosensitive dye adsorbed on the semiconductor layer 16, by blocking an ultraviolet band of the incident light, and thus, a durability of the photoelectric panel 15 may be improved. The ultraviolet ray blocking film 12 may be formed by coating a coating liquid, including, e.g., an aluminum doped zinc oxide (AZO), on the first substrate 10.

The ultraviolet ray blocking film 12 may be directly formed on the photoelectric panel 15, as illustrated in FIG. 3. However, the ultraviolet ray blocking film 12 may also be formed spaced apart from the photoelectric panel 15, and also, an ultraviolet ray blocking function may be performed by an external protection glass (not shown) spaced apart from the photoelectric panel 15. That is, the photoelectric panel 15 may be disposed in the external protection glass (not shown) inserted in the window area W, and in this case, an ultraviolet ray blocking function may be performed by the external protection glass (not shown). That is, the external protection glass may be between the photoelectric panel 15 and a source of ultraviolet rays.

FIG. 4 illustrates a lighting apparatus according to an embodiment.

Referring to FIG. 4, the lighting apparatus may be an external lighting apparatus and may include a window frame 200 that forms an external appearance, a plurality of photoelectric panels 15 fixed to the window frame 200, and a plurality of glass panels 30 fixed to the window frame 200. The window frame 200 may be formed to define a plurality of window areas W each having a substantially rectangular form and may fix the photoelectric panels 15 and the glass panels 30, which may be disposed in different window areas W, to one side of a wall of a building.

For example, the window frame 200 may include a plurality of first frames 201 that extend side-by-side in a first direction Z1 and a plurality of second frames 202 that extend side-by-side in a second direction Z2, and the plurality of window areas W may be defined by the first and second frames 201 and 202. The glass panels 30 may be fixed to window areas W located on the center portion of the window frame 100, and the photoelectric panels 15 may be fixed to window areas W located on the upper and lower portions of the window frame 200. The photoelectric panels 15 may be fixed to the window frame 200 with hinges and may rotate on first and second hinge axis C1 and C2. For example, each of the photoelectric panels 15 located on the upper portion of the window frame 200 may be fixed to the window frame 200 and may rotate on the first hinge axis C1, and each of the photoelectric panels 15 located on the lower portion of the window frame 200 may be fixed to the window frame 200 and may rotate on the second hinge axis C2. A hinge structure of the photoelectric panels 15 is described in greater detail below.

Exterior lighting units 50 may be disposed on the window frame 200. For example, the exterior lighting units 50 may be arranged along the window frame 200, and may be arranged along a portion of the window frame 200. In the embodiment illustrated in FIG. 4, the exterior lighting units 50 may be arranged only in a portion of the window frame 200 that surrounds the glass panels 30, and may be arranged along a first frame 201 adjacent to the glass panels 30. In this case, the exterior lighting units 50 may be disposed in a buried form in the window frame 100. That is, the exterior lighting units 50 may be disposed in the first frames 101 so that the exterior lighting units 50 are not directly exposed to the outside. The exterior lighting apparatus may include a battery unit 230 that stores an electric power generated by the photoelectric panels 15 and supplies a power supply voltage to the exterior lighting units 50.

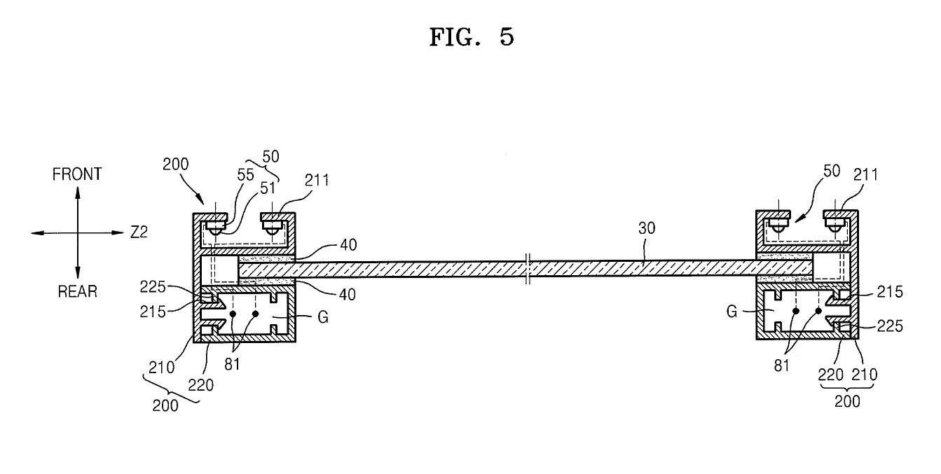

FIG. 5 illustrates a cross-sectional view taken along line V-V of FIG. 4.

As illustrated in FIG. 5, the window frame 200 may be coupled to edges of the glass panel 30 and may fix positions of the glass panel 30 by supporting the edges. The window frame 200 may include a base frame 210 that extends indoors and outdoors, that is, to the front and rear, and a coupling frame 220 that is coupled at the rear side of the base frame 210 and supports the glass panel 30 between the base frame 210 and the coupling frame 220.

The base frame 210 may be opposite to the front of the glass panel 30 (i.e., may overlap a portion of the front side of the glass panel 30) and may extend to the rear side of the glass panel 30 by crossing the lateral side of the glass panel 30 (i.e., a side of the glass panel 30 facing along the Z2 direction in FIG. 5). The coupling frame 220 may be opposite to the rear of the glass panel 30 (i.e., may overlap a portion of the rear side of the glass panel 30) and may be coupled to the base frame 210 to fix the glass panel 30 between the base frame 210 and the coupling frame 220. For example, the base frame 210 may be close to (e.g., connected to) the front of the glass panel 30 by interposing a bumper 40, and the coupling frame 220 may be close to (e.g., connected to) the rear of the glass panel 30 by interposing the bumper 40. The use of the terms “front” and “rear” above are by way of example, and the base frame 210 and the coupling frame 220 may be disposed opposite to the rear of the glass panel 30 and the front of the glass panel 30, respectively, and may be close to the rear of the glass panel 30 and the front of the glass panel 30, respectively, by interposing a bumper 40.

A pair of limb portions 215 may be formed in the base frame 210, and the base frame 210 and the coupling frame 220 may be coupled to each other by the limb portions 215 catching a clasp 225 of the coupling frame 220.

A pair of flange portions 211 may be to be opposite to each other and may be formed at the front end portion of the base frame 210, and the exterior lighting units 50 may be supported on the flange portions 211. The flange portions 211 may be bent in a direction facing the front of the glass panel 30. The exterior lighting units 50 may be disposed on the flange portions 211 and may emit light in a direction facing the glass panel 30, that is, towards the rear. The optical axis O of the exterior lighting units 50 may be set in the direction facing the glass panel 30. For example, the optical axis O of the exterior lighting units 50 may be set in a direction substantially perpendicular to the front of the glass panel 30.

Each of the exterior lighting units 50 may include an LED array including a plurality of LED devices. The exterior lighting units 50 each may include a light-emitting unit 51 and a circuit substrate 55 for supplying an electrical signal to the light-emitting unit 51.

The exterior lighting units 50 may receive a driving power from the battery unit 230 of FIG. 4. A first interconnection line 81 for supplying the electric power from the battery unit 230 to the exterior lighting units 50 may extend from the exterior lighting units 50 to the battery unit 230 and may be formed in the window frame 200. For example, the first interconnection line 81 may be disposed in an interconnection space G of the window frame 200 and may extend along the window frame 200. The interconnection space G may be formed by coupling of the base and coupling frames 210 and 220.

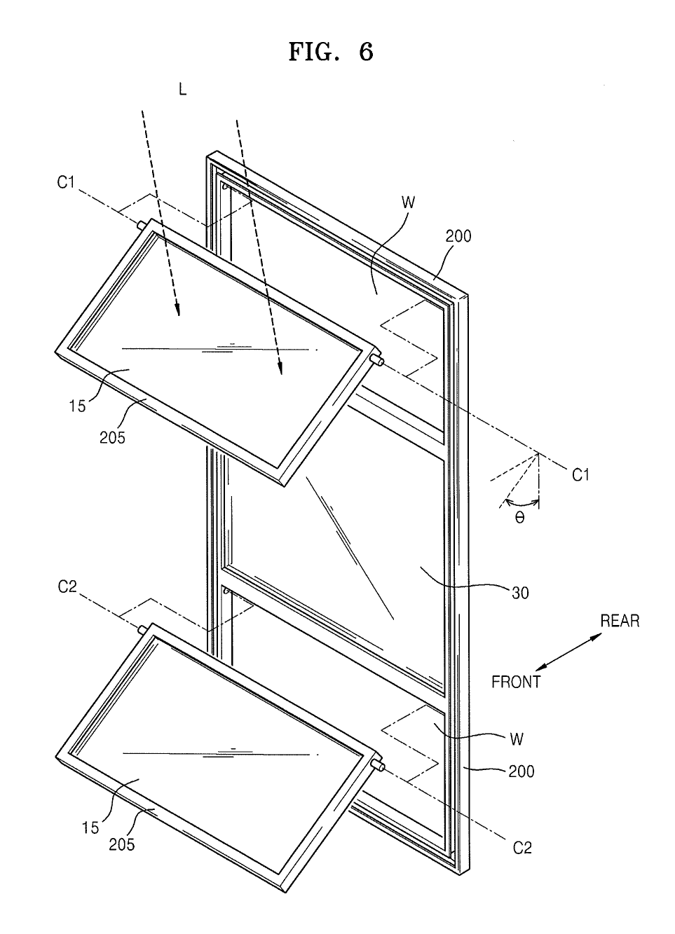

FIG. 6 illustrates a rotation and movement structure of the photoelectric panel 15 illustrated in FIG. 4. Referring to FIG. 6, each photoelectric panel 15 may be disposed in window areas W located on an upper portion and lower portion of the window frame 200, and each photoelectric panel 15 may be fixed to the window areas W of the window frame 200 with hinges and may rotate on an axis. The glass panel 30 may be located on the center portion of the window frame 200.

A window frame 205 may be formed along edges of the photoelectric panel 15, and may be fixed along a hinge axis C1 or C2 through one side of the window frame 205. For example, the photoelectric panel 15 may be installed to rotate on the hinge axis C1 or C2 at a rotation angle θ in the range of 45° to 90°.

As explained above, the photoelectric panel 15 may rotate, and thus electric power may be efficiently generated and a ventilation structure through which the interior of a room communicates with the outside of the room may be formed. For example, a rotation angle θ of the photoelectric panel 15 may be changed according to a radiation angle of an incident light, e.g., sunlight L, and the photoelectric panel 15 may rotate with an optimum rotation angle, e.g., a rotation angle at which the amount of received light may be maximized within a permitted limit, according to the radiation angle of the sunlight L, which may change slightly under different environments and/or at different times. In addition, the interior of a room may or may not communicate with the outside of the room according to opening or closing of the photoelectric panel 15, and ventilation may be controlled according to the opening or closing of the photoelectric panel 15.

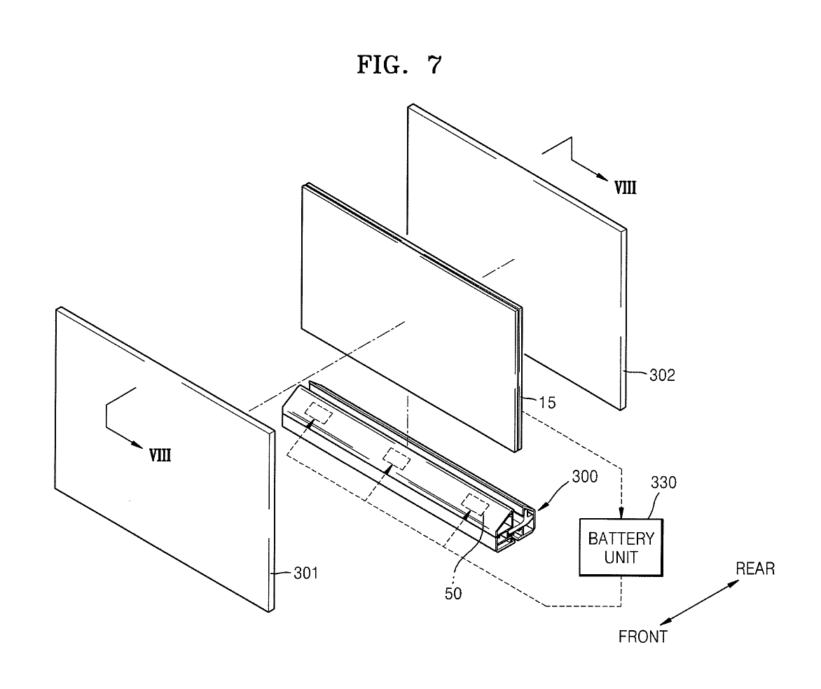

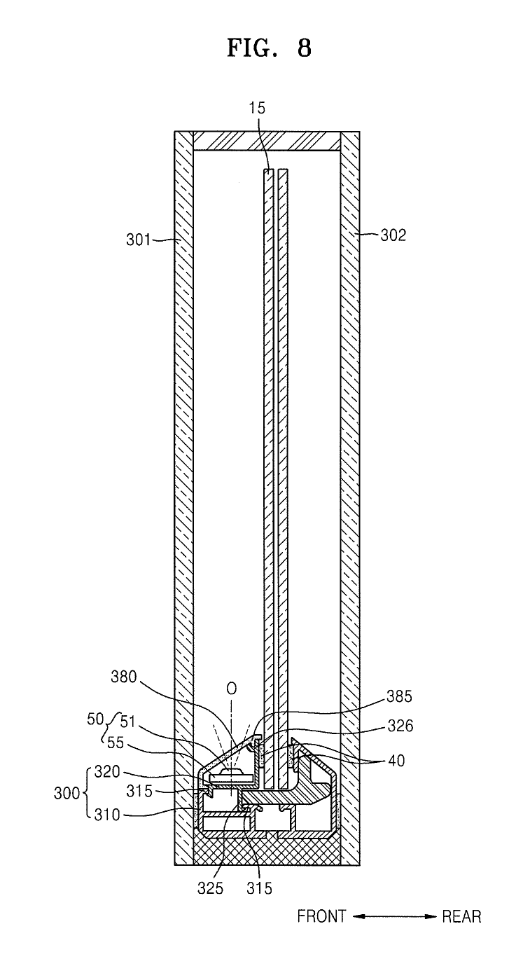

FIG. 7 illustrates a perspective view of a lighting apparatus according to an embodiment. FIG. 8 is a cross-sectional view taken along line VIII-VIII of FIG. 7.

Referring to FIGS. 7 and 8, the lighting apparatus may be an external lighting apparatus and may include a double window that includes an external panel 301 located on the front side and an internal panel 302 located on the rear side. That is, the exterior lighting apparatus may include a photoelectric panel 15 interposed between the external panel 301 and the internal panel 302 and a supporting frame 300 for supporting the exterior lighting units 50 as well as the photoelectric panel 15. The supporting frame 300 may be between the external panel 301 and the internal panel 302 and may support the photoelectric panel 15 and the exterior lighting units 50.

The photoelectric panel 15 may receive an incident light, for example, sunlight, and may perform an electric power generation operation. Electric power generated from the photoelectric panel 15 may be stored in a battery unit 330, and the electric power stored in the battery unit 330 may be used as a power supply of the exterior lighting units 50. For example, electric power generated by the photoelectric panel 15 during the daytime may be stored in the battery unit 330, and the electric power stored in the battery unit 330 may be used as a driving electric power for driving the exterior lighting units 50 at night. The exterior lighting units 50 may be disposed on the supporting frame 300 and may include an LED array formed of a plurality of LED devices.

Referring to FIG. 8, the supporting frame 300 may include the base frame 310 and the coupling frame 320 that is coupled to the base frame 310 by interposing the photoelectric panel 15 therebetween. For example, the base frame 310 may have a shape surrounding edge portions of the photoelectric panel 15 and may contact the rear of the photoelectric panel 15 by interposing a bumper 40. The coupling frame 320 may be coupled to the front side of the base frame 310 by interposing the photoelectric panel 15. For example, the coupling frame 320 may contact the front surface of the photoelectric panel 15 by interposing the bumper 40. The base frame 310 and the coupling frame 320 may include a portion facing the rear of the photoelectric panel 15 and a portion facing the front of the photoelectric panel 15, respectively, and the photoelectric panel 15 may be fixed with a pressure by the portions between the base frame 310 and the coupling frame 320. However, the base frame 310 and the coupling frame 320 may also be disposed so as to face the front of the photoelectric panel 15 and the rear of the photoelectric panel 15, respectively.

The photoelectric panel 15 may be fixed according to the coupling between the base frame 310 and the coupling frame 320. With respect to the coupling between the base frame 310 and the coupling frame 320, a limb portion 325 may be formed in the coupling frame 320, and the coupling frame 320 and the base frame 310 may be coupled to each other by the limb portion 325 catching a clasp 315 of the base frame 310. The coupling structure between the coupling frame 320 and the base frame 310 may be a suitable structure, and the structure described above is given only by way of example.

The supporting frame 300 may fix the photoelectric panel 15 and also may provide an installation location of the exterior lighting units 50. The exterior lighting units 50 may be disposed on the coupling frame 320 of the supporting frame 300. The exterior lighting units 50 may be installed on the coupling frame 320 and may have an optical axis O parallel to the photoelectric panel 15. That is, the optical axis O of the exterior lighting units 50 may be set parallel to a main surface of the photoelectric panel 15. Accordingly, the exterior lighting units 50 may not directly expose light sources to the outside and may implement indirect lighting that uses light reflected or diffused from the light sources. Thus, the dazzling effect that occurs when directly emitting light to the outside may be substantially prevented. In addition, the exterior lighting units 50 may provide an elegant light having a dim and soft visual effect by implementing the indirect lighting without using light directly emitted from the light sources.

The exterior lighting units 50 may be disposed on the coupling frame 320 and may be protected by a cover element 380 that is coupled to the coupling frame 320. The cover element 380 may be formed of a transparent/translucent material capable of transmitting light that is emitted from the exterior lighting units 50.

With respect to the coupling between the cover element 380 and the coupling frame 320, the cover element 380 may be detachably coupled to the coupling frame 320. Accordingly, when the maintenance of the exterior lighting units 50 is required, the cover element 380 may be detached and then the exterior lighting units 50 may be repaired or replaced with other exterior lighting units. The cover element 380 may cover exterior lighting units 50 installed on the coupling frame 320, and for this, location fixing units 326 and 385 may be disposed in corresponding locations of the cover element 380 and the coupling frame 320.

The exterior lighting units 50 each may include an LED array formed of a plurality of LED devices. For example, the exterior lighting units 50 each may include a light-emitting unit 51 and a circuit substrate 55 for supplying an electrical signal to the light-emitting unit 51.

The supporting frame 300 may be formed of a metal material, and for example, may be formed of an aluminum material. The supporting frame 300 formed of a metal material may function as a heat dissipation plate against heat of the exterior lighting units 50. That is, it may not be necessary to install a separate heat dissipation plate by installing the exterior lighting units 50 on the supporting frame 300 (although a separate heat dissipation plate may also be used). The whole supporting frame 300 may be formed of a metal material, or a portion of the supporting frame 300, for example, the coupling frame 320 on which the exterior lighting units 50 are mounted, may be selectively formed of a metal material.

By way of summary and review, the decorative lighting of a building may raise the value of the building, leading to interest in and use of such decorative lighting. When decorative lighting is used, however, additional energy consumption may result, and thus power costs may increase. A decorative lighting apparatus using a solar cell according to the one or more of the above embodiments may substantially reduce or eliminate power consumption associated with such lighting units by using electric power generated by a photoelectric panel as a power supply of the lighting units. In addition, the decorative lighting apparatus may further reduce power consumption by using a photoelectric panel formed of a dye-sensitized solar cell or an organic solar cell having relatively high electric power generation efficiency, and using lighting units formed of low power LED devices. Power consumption may be further reduced by enhancing heat dissipation through the frame on which the decorative lighting units are located.

When decorative lighting apparatuses directly emit light to the outside, such as to the exterior of a building, a dazzling effect may occur. This dazzling effect may cause visual unpleasantness, accidents (i.e., by causing a distraction), and/or light pollution. The foregoing conditions may be circumvented by use of the lighting apparatus disclosed herein, which may indirectly emit light. The indirect lighting according to the embodiments may also provide a soft aesthetic effect and a visually elegant appearance.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A lighting apparatus using a solar cell, the apparatus comprising:
a window frame that frames a window area;
a photoelectric panel in the window area;
a battery unit that stores electric power generated from the photoelectric panel; and
a lighting unit that receives a power supply voltage from the battery unit and provides indirect lighting, the lighting unit being on the window frame, and an optical axis of the lighting unit extends in a direction facing the photoelectric panel.

2. The apparatus as claimed in claim 1, wherein the photoelectric panel includes a dye-sensitized solar cell or an organic solar cell.

3. The apparatus as claimed in claim 1, wherein the lighting apparatus is an exterior lighting apparatus further including a glass panel that transmits an incident light as indoor lighting.

4. The apparatus as claimed in claim 3, wherein the window frame frames a plurality of window areas, and the photoelectric panel and the glass panel are in different window areas.

5. The apparatus as claimed in claim 1, wherein the lighting unit includes a light-emitting diode (LED) array arranged along the window frame.

6. The apparatus as claimed in claim 1, wherein:
the lighting apparatus is an exterior lighting apparatus,
a flange portion of an end portion of an outdoor side of the window frame is bent to be opposite to the photoelectric panel, and
the lighting unit is on the flange portion.

7. The apparatus as claimed in claim 6, wherein the flange portion includes an aluminum material.

8. The apparatus as claimed in claim 1, wherein the photoelectric panel is fixed to the window frame with a hinge so that the photoelectric panel rotates with respect to the window frame.

9. The apparatus as claimed in claim 1, wherein the window frame includes:
a base frame that faces a first side of the photoelectric panel and extends across a lateral side of the photoelectric panel; and
a coupling frame that faces a second side of the photoelectric panel and is coupled to the base frame, the second side being opposite the first side.

10. The apparatus as claimed in claim 9, wherein the photoelectric panel is fixed between the base frame and the coupling frame.

11. The apparatus as claimed in claim 10, wherein the lighting unit faces the photoelectric panel, the base frame, and the coupling frame.

12. The apparatus as claimed in claim 9, wherein there is an interconnection space between the base frame and the coupling frame, and the interconnection space accommodates a first interconnection line that electrically connects the lighting unit and the battery unit, and a second interconnection line that electrically connects the photoelectric panel and the battery unit.

13. The apparatus as claimed in claim 1, wherein the lighting unit is an exterior lighting unit on an exterior side of the window frame, and the lighting unit is hidden by the window frame when viewed from the exterior side.

14. The apparatus as claimed in claim 1, further comprising an ultraviolet ray blocking film on the photoelectric panel.

15. A lighting apparatus using a solar cell, the apparatus comprising:
a first panel and a second panel that face each other;
a supporting frame interposed between the first panel and the second panel;
a photoelectric panel fixed to the supporting frame;
a battery unit that stores electric power generated from the photoelectric panel; and
a lighting unit that receives a power supply voltage from the battery unit and provides indirect lighting, the lighting unit being on the supporting frame, and an optical axis of the lighting unit extends in a direction parallel to the photoelectric panel.

16. The apparatus as claimed in claim 15, wherein the supporting frame includes:
a base frame that is on a first side of the photoelectric panel; and
a coupling frame that is on a second side of the photoelectric panel and is coupled to the base frame, the second side being opposite the first side.

17. The apparatus as claimed in claim 16, wherein the photoelectric panel is fixed between the base frame and the coupling frame.

18. The apparatus as claimed in claim 16, wherein the lighting unit is on the coupling frame and is protected by a cover element that is coupled to the coupling frame.

19. The apparatus as claimed in claim 18, wherein the cover element is detachably coupled to the coupling frame.

20. The apparatus as claimed in claim 15, wherein:
the first panel is an external panel,
the second panel is an internal panel,
the lighting unit is an exterior lighting unit and is between the photoelectric panel and the first panel.
